(19) United States
(12) Patent Application Publication
(10) Pub. No.: US 2026/0057303 A1
(43) Pub. Date: Feb. 26, 2026

(54) METHODS, APPARATUS AND MEDIUM FOR TRAINING AN ARTIFICIAL INTELLIGENCE OR MACHINE LEARNING MODEL

(71) Applicant: Huawei Technologies Co., Ltd., Shenzhen (CN)

(72) Inventors: Hao Tang, Ottawa (CA); Adam Christian Cavatassi, Mississauga (CA); Yiqun Ge, Ottawa (CA); Liqing Zhang, Ottawa (CA); Jianglei Ma, Ottawa (CA)

(21) Appl. No.: 19/329,004

(22) Filed: Sep. 15, 2025

Related U.S. Application Data
(63) Continuation of application No. PCT/CN2023/082019, filed on Mar. 16, 2023.

(51) Int. Cl. G06N 20/00

(52) U.S. Cl. CPC G06N 20/00

(57) ABSTRACT

Aspects of the present disclosure provide methods and apparatuses for training an artificial intelligence or machine learning (AI/ML) model to support deep neural network (DNN)-based applications and DNN-based services in a communication network. According to some embodiments, a user equipment (UE) may receive, from a base station (BS), training configuration information for a learning block comprising one or more successive layers of the AI/ML model. The learning block may include a subset of less than all layers of the AI/ML model. The UE may determine the learning block using the training configuration information. The UE may train the AI/ML model or the learning block using the training configuration information. The UE may transmit, to the BS, one or more parameters associated with the learning block.

### CROSS-REFERENCE TO RELATED APPLICATION

This application is a continuation of International Application No. PCT/CN2023/082019, filed on Mar. 16, 2023, which is hereby incorporated by reference in its entirety.

### TECHNICAL FIELD

The present disclosure relates to wireless communication generally, and, in particular, to methods and apparatuses for training an artificial intelligence or machine learning (AI/ML) model in a communication network.

### BACKGROUND

In the field of artificial intelligence (AI), an AI model may be implemented using one or more neural networks such as deep neural networks (DNN). A DNN may include a vast quantity of layers and interconnected neurons and may employ deep learning when operating as intended. Deep learning may be seen to involve implementing two cycles. The first cycle is training (or learning) cycle, and the second cycle is inference (or reasoning) cycle.

In the training cycle, training data and a specific training goal or target are used to train the DNN. More specifically, the training data is used to adjust coefficients of the neurons of the DNN so that, eventually, the trained DNN fulfills the specific training goal or target. In the inference cycle, an input data sample is fed into the trained DNN. In response to receiving the input data sample, the DNN outputs a prediction.

### SUMMARY

Aspects of the present disclosure provide specific methods and apparatuses for training an artificial intelligence or machine learning (AI/ML) model to support deep neural network (DNN)-based applications and DNN-based services in future communications systems which may include wireless communications systems, wired communications systems, or a mix of wireless and wired communications systems.

According to a first broad aspect of the present disclosure, there is provided herein a method for training an artificial intelligence or machine learning (AI/ML) model in a communication network. The method according to the first broad aspect of the present disclosure may include receiving, by a user equipment (UE) from a base station (BS), training configuration information for a learning block comprising one or more successive layers of the AI/ML model, the learning block including a subset of less than all layers of the AI/ML model; determining, by the UE, the learning block using the training configuration information; training, by the UE, the AI/ML model or the learning block using the training configuration information; and transmitting, by the UE to the BS, one or more parameters associated with the learning block.

In some embodiments, the one or more successive layers of the AI/ML model is to be trained together.

In some embodiments, the UE trains the AI/ML model or the learning block using AI/ML model training data, wherein the AI/ML model training data is generated by the UE, or wherein the AI/ML model training data is received from the BS or another UE.

In some embodiments, the method according to the first broad aspect of the present disclosure further includes transmitting, by the UE to the BS, information indicative of computing capability of the UE.

In some embodiments, the training configuration information comprises at least one of: information indicative of a first layer of the learning block; information indicative of the last layer of the learning block; an AI/ML model training pattern indicating a plurality of blocks in the AI/ML model and a number of iterations for each of the plurality of blocks; information related to one or more preceding layers to the learning block; a kernel function for AI/ML model training input data; or a kernel function for AI/ML model training output data.

In some embodiments, the AI/ML model training output data is one or more data labels of the AI/ML model training input data.

In some embodiments, the training configuration information does not comprise the kernel function for the AI/ML model training input data and the kernel function for the AI/ML model training output data, and wherein the kernel function for the AI/ML model training input data and the kernel function for the AI/ML model training output data are predefined.

In some embodiments, the training configuration information comprises the kernel function for the AI/ML model training input data and the kernel function for the AI/ML model training output data or the kernel function for the AI/ML model training input data and the kernel function for the AI/ML model training output data are predefined. In such embodiments, the method according to the first broad aspect of the present disclosure further includes transmitting, by the UE to the BS, kernelized AI/ML model training input data and kernelized AI/ML model training output data.

In some embodiments, the training configuration information comprises the kernel function for the AI/ML model training output data or the kernel function for the AI/ML model training input data and the kernel function for the AI/ML model training output data are predefined. In such embodiments, the method according to the first broad aspect of the present disclosure further includes calculating, by the UE, the kernelized AI/ML model training output data using the AI/ML model training output data and the kernel function for the AI/ML model training output data; and transmitting, by the UE to the BS, the kernelized AI/ML model training output data.

In some embodiments, the training configuration information comprises the kernel function for the AI/ML model training output data or the kernel function for the AI/ML model training input data and the kernel function for the AI/ML model training output data are predefined. In such embodiments, the method according to the first broad aspect of the present disclosure further includes receiving, by the UE from the BS, at least one of kernelized AI/ML model training input data or kernelized AI/ML model training output data.

In some embodiments, the UE receives both the kernelized AI/ML model training input data and the kernelized AI/ML model training output data, and the information related to the one or more preceding layers comprises one or more parameters associated with the one or more preceding layers; or an input of the learning block.

In some embodiments, the one or more preceding layers are frozen, and the learning block of the AI/ML model is trained using a backpropagation algorithm.

In some embodiments, the method according to the first broad aspect of the present disclosure further includes receiving, by the UE, a switching signal to start training the learning block via radio resource control (RRC) signaling, media access control-control element (MAC-CE) signaling, or downlink control information (DCI) signaling, or event signaling indicating completion of a preceding learning block training.

In some embodiments, the switching signal comprises a learning block identifier assigned to the learning block.

In some embodiments, the method according to the first broad aspect of the present disclosure further includes transmitting, by the UE to the BS, at least one of an indication for loss of at least one layer of the one or more successive layers of the learning block or an indication for updating the one or more parameters associated with the learning block.

In some embodiments, the method according to the first broad aspect of the present disclosure further includes receiving, by the UE from the BS, an instruction for at least one of: transmitting kernelized AI/ML model training input data and kernelized AI/ML model training output data, or suspending the AI/ML model training; suspending, by the UE, the AI/ML model training; and transmitting, by the UE to the BS, the kernelized AI/ML model training input data and the kernelized AI/ML model training output data.

In some embodiments, the method according to the first broad aspect of the present disclosure further includes receiving, by the UE from another UE, at least one of kernelized AI/ML model training input data or kernelized AI/ML model training output data.

In some embodiments, the method according to the first broad aspect of the present disclosure further includes transmitting, by the UE to the BS, information indicative of at least one of: whether the UE has the AI/ML model training input data and the AI/ML model training output data; or amount of the AI/ML model training input data and the AI/ML model training output data.

In some embodiments, the amount of the AI/ML model training input data and the AI/ML model training output data is less than a predetermined amount. In such embodiments, the method according to the first broad aspect of the present disclosure further includes receiving, by the UE from the BS or another UE, at least one of: additional AI/ML model training input data and additional AI/ML model training output data; or additional kernelized AI/ML model training input data and additional kernelized AI/ML model training output data.

In some embodiments, the additional AI/ML model training output data is data labels of the additional AI/ML model training input data.

In some embodiments, the method according to the first broad aspect of the present disclosure further includes receiving, by the UE from the BS, information indicative of an AI/ML model training mode, the AI/ML model training mode indicating whether whole of the AI/ML model is to be trained or only part of the AI/ML model is to be trained; and switching or keeping or activating, by the UE, the AI/ML model training mode based on the information indicative of the AI/ML model training mode.

In some embodiments, the AI/ML model training mode indicates whole of the AI/ML model is to be trained, and the UE trains the AI/ML model using at least one of a forward propagation algorithm or a backpropagation algorithm.

In some embodiments, the AI/ML model training mode indicates only part of the AI/ML model is to be trained, and the UE trains the learning block without using a backpropagation algorithm.

In some embodiments, when the UE activates the AI/ML model training mode, the UE starts training the learning block only using the forward propagation algorithm.

In some embodiments, the information indicative of the AI/ML model training mode is received via RRC signaling, MAC-CE signaling, or DCI signaling.

In some embodiments, the AI/ML model training mode is determined based on at least one of: an AI/ML model training stage; a power capacity of the UE; a buffer size supported by the UE; an AI/ML model size supported by the UE; an AI/ML model complexity supported by the UE; power saving requirement of the UE; or processing capability of the UE.

In some embodiments, the method according to the first broad aspect of the present disclosure further includes receiving, by the UE from the BS, information indicative of at least one of time resource, frequency resource, or spatial resource for reporting loss of the learning block or loss convergence status of the learning block via RRC signaling, MAC-CE signaling, DCI signaling or event signaling indicating when to report the loss of the learning block or the loss convergence status of the learning block.

In some embodiments, the method according to the first broad aspect of the present disclosure further includes transmitting, by the UE to the BS, information indicative of the loss of the learning block or the loss convergence status of the learning block.

In some embodiments, the BS determines a starting layer of the learning block and an ending layer of the learning block. In such embodiments, the method according to the first broad aspect of the present disclosure further includes transmitting, by the UE to the BS, an index of the learning block.

In some embodiments, the UE determines a starting layer of the learning block and an ending layer of the learning block. In such embodiments, the method according to the first broad aspect of the present disclosure further includes transmitting, by the UE to the BS, information indicative of the starting layer of the learning block and the ending layer of the learning block.

According to a second broad aspect of the present disclosure, there is provided herein a method for training an artificial intelligence or machine learning (AI/ML) in a communication network. The method according to the second broad aspect of the present disclosure may include transmitting, by a base station (BS) to a user equipment (UE), training configuration information for a learning block comprising one or more successive layers of the AI/ML model, the learning block including less than all layers of the AI/ML model, wherein the training configuration information is to be used for: determining the learning block, and training the AI/ML model or the learning block; and receiving, by the BS from the UE, one or more parameters associated with the learning block.

In some embodiments, the one or more successive layers of the AI/ML model is to be trained together.

In some embodiments, the method according to the second broad aspect of the present disclosure further includes transmitting, by the BS, AI/ML model training data to be used for training the AI/ML model or the learning block.

In some embodiments, the method according to the second broad aspect of the present disclosure further includes receiving, by the BS from the UE, information indicative of computing capability of the UE.

In some embodiments, the training configuration information comprises at least one of: information indicative of a first layer of the learning block; information indicative of the last layer of the learning block; an AI/ML model training pattern indicating a plurality of blocks in the AI/ML model and a number of iterations for each of the plurality of blocks; information related to one or more preceding layers to the learning block; a kernel function for AI/ML model training input data; or a kernel function for AI/ML model training output data.

In some embodiments, the AI/ML model training output data is one or more data labels of the AI/ML model training input data.

In some embodiments, the training configuration information comprises at least one of the kernel function for the AI/ML model training input data or the kernel function for the AI/ML model training output data. In such embodiments, the method according to the second broad aspect of the present disclosure further includes configuring, by the BS, at least one of the kernel function for the AI/ML model training input data or the kernel function for the AI/ML model training output data.

In some embodiments, the training configuration information comprises the kernel function for the AI/ML model training input data and the kernel function for the AI/ML model training output data or the kernel function for the AI/ML model training input data and the kernel function for the AI/ML model training output data are predefined. In such embodiments, the method according to the second broad aspect of the present disclosure further includes receiving, by the BS from the UE, kernelized AI/ML model training input data and kernelized AI/ML model training output data.

In some embodiments, the amount of the kernelized AI/ML model training input data and the kernelized AI/ML model training output data is less than a predetermined amount. In such embodiments, the method according to the second broad aspect of the present disclosure further includes transmitting, by the BS to another BS, the kernel function for the AI/ML model training input data and the kernel function for the AI/ML model training output data, wherein the other BS generates additional kernelized AI/ML model training input data and additional kernelized AI/ML model training output data using the kernel function for the AI/ML model training input data and the kernel function for the AI/ML model training output data; receiving, by the BS from the other BS, the additional kernelized AI/ML model training input data and the additional kernelized AI/ML model training output data; and training, by the BS, the learning block using the kernelized AI/ML model training input data, the kernelized AI/ML model training output data, the additional kernelized AI/ML model training input data, and the additional kernelized AI/ML model training output data.

In some embodiments, the training configuration information comprises the kernel function for the AI/ML model training output data or the kernel function for the AI/ML model training input data and the kernel function for the AI/ML model training output data are predefined. In such embodiments, the method according to the second broad aspect of the present disclosure further includes receiving, by the BS from the UE, the kernelized AI/ML model training output data; calculating, by the BS, the kernelized AI/ML model training input data using the AI/ML model training input data and the kernel function for the AI/ML model training input data; and training, by the BS, the learning block using the kernelized AI/ML model training input data and the kernelized AI/ML model training output data.

In some embodiments, the training configuration information comprises the kernel function for the AI/ML model training output data or the kernel function for the AI/ML model training input data and the kernel function for the AI/ML model training output data are predefined. In such embodiments, the method according to the second broad aspect of the present disclosure further includes transmitting, by the BS to the UE, at least one of kernelized AI/ML model training input data or kernelized AI/ML model training output data.

In some embodiments, the BS has the AI/ML model training input data and the kernel function for the AI/ML model training input data. In such embodiments, the method according to the second broad aspect of the present disclosure further includes calculating, by the BS, the kernelized AI/ML model training input data using the AI/ML model training input data and the kernel function for the AI/ML model training input data.

In some embodiments, the BS transmits both the kernelized AI/ML model training input data and the kernelized AI/ML model training output data, and the information related to the one or more preceding layers comprises: one or more parameters associated with the one or more preceding layers; or an input of the learning block.

In some embodiments, the one or more preceding layers are frozen, and the learning block of the AI/ML model is trained using a backpropagation algorithm.

In some embodiments, the method according to the second broad aspect of the present disclosure further includes transmitting, by the BS, a switching signal to start training the learning block via radio resource control (RRC) signaling, media access control-control element (MAC-CE) signaling, or downlink control information (DCI) signaling, or event signaling indicating completion of a preceding learning block training.

In some embodiments, the switching signal comprises a learning block identifier assigned to the learning block.

In some embodiments, the method according to the second broad aspect of the present disclosure further includes receiving, by the BS from the UE, at least one of an indication for loss of at least one layer of the one or more successive layers of the learning block or an indication for updating the one or more parameters associated with the learning block.

In some embodiments, the method according to the second broad aspect of the present disclosure further includes transmitting, by the BS to the UE, an instruction for at least one of: transmitting kernelized AI/ML model training input data and kernelized AI/ML model training output data, or suspending the AI/ML model training; and receiving, by the BS from the UE, the kernelized AI/ML model training input data and the kernelized AI/ML model training output data.

In some embodiments, the method according to the second broad aspect of the present disclosure further includes receiving, by the BS from the UE, information indicative of at least one of: whether the UE has the AI/ML model training input data and the AI/ML model training output data; or amount of the AI/ML model training input data and the AI/ML model training output data.

In some embodiments, the amount of the AI/ML model training input data and the AI/ML model training output data is less than a predetermined amount. In such embodiments, the method according to the second broad aspect of the present disclosure further includes transmitting, by the BS to the UE, at least one of: additional AI/ML model training input data and additional AI/ML model training output data; or additional kernelized AI/ML model training input data and additional kernelized AI/ML model training output data.

In some embodiments, the additional AI/ML model training output data is data labels of the additional AI/ML model training input data.

In some embodiments, the method according to the second broad aspect of the present disclosure further includes transmitting, by the BS to the UE, information indicative of an AI/ML model training mode, the AI/ML model training mode indicating whether whole of the AI/ML model is to be trained or only part of the AI/ML model is to be trained.

In some embodiments, the AI/ML model training mode indicates whole of the AI/ML model is to be trained, and the AI/ML model is trained using at least one of a forward propagation algorithm or a backpropagation algorithm.

In some embodiments, the AI/ML model training mode indicates only part of the AI/ML model is to be trained, and the learning block is trained without using a backpropagation algorithm.

In some embodiments, the BS transmits the information indicative of the AI/ML model training mode via RRC signaling, MAC-CE signaling, or DCI signaling.

In some embodiments, the AI/ML model training mode is determined based on at least one of: an AI/ML model training stage; a power capacity of the UE; a buffer size supported by the UE; an AI/ML model size supported by the UE; an AI/ML model complexity supported by the UE; power saving requirement of the UE; or processing capability of the UE.

In some embodiments, the method according to the second broad aspect of the present disclosure further includes transmitting, by the BS to the UE, information indicative of at least one of time resource, frequency resource, or spatial resource for reporting loss of the learning block or loss convergence status of the learning block via RRC signaling, MAC-CE signaling, DCI signaling or event signaling indicating when to report the loss of the learning block or the loss convergence status of the learning block.

In some embodiments, the method according to the second broad aspect of the present disclosure further includes receiving, by the BS from the UE, information indicative of the loss of the learning block or the loss convergence status of the learning block.

In some embodiments, the BS determines a starting layer of the learning block and an ending layer of the learning block. In such embodiments, the method according to the second broad aspect of the present disclosure further includes receiving, by the BS from the UE, an index of the learning block.

In some embodiments, the UE determines a starting layer of the learning block and an ending layer of the learning block. In such embodiments, the method according to the second broad aspect of the present disclosure further includes receiving, by the BS from the UE, information indicative of the starting layer of the learning block and the ending layer of the learning block.

Corresponding apparatuses and devices are disclosed for performing the methods.

For example, according to another aspect of the disclosure, a device is provided that includes a processor and a memory storing processor-executable instructions that, when executed, cause the processor to carry out a method according to the first broad aspect or the second broad aspect of the present disclosure described above.

According to another aspect of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

According to another aspect of the disclosure, there is provided a non-transitory computer readable storage medium, wherein the computer readable storage medium stores instructions that, when executed by a processor of an apparatus, enable the apparatus to perform a method according to the first broad aspect or the second broad aspect of the present disclosure described above.

By virtue of some aspects of the present disclosure, an AI/ML model may be trained using forward-propagation-only (FO) training methods over air interface in future communications systems, such as sixth generation (6G) wireless network systems.

By virtue of some aspects of the present disclosure, forward-propagation-only (FO) training methods and backpropagation (BP) training methods may be flexibly adapted for an AI/ML model training. In other words, some aspects of the present disclosure may support flexible adaptation of FO and BP training methods.

By virtue of some aspects of the present disclosure, incremental AI/ML model learning may be supported thereby reducing AI/ML model training overhead and/or signaling overhead for transmission of AI/ML model parameters, especially compared to full AI/ML model training (e.g., training whole AI/ML model).

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates four EDs communicating with a network device in a communication system, according to embodiments of the present disclosure;

FIG. 6A illustrates and example of a neural network with multiple layers of neurons, according to embodiments of the present disclosure;

FIG. 6B illustrates an example of a neuron that may be used as a building block for a neural network, according to embodiments of the present disclosure;

FIG. 7 illustrates an example of transmitting private information of a deep neural network (DNN) model to a cloud computing system for the DNN model training;

FIG. 8 illustrates an example of a conventional AI/ML model training using a backpropagation (BP) algorithm;

FIG. 9A illustrates an example of learning block switching where each learning block is trained sequentially after the preceding learning block, according to embodiments of the present disclosure;

FIG. 9B illustrates an example of learning block switching where some of the learning blocks are trained at a base station (BS) and other learning blocks are trained at a user equipment (UE), according to embodiments of the present disclosure;

FIG. 10 illustrates an example of training a learning block where a UE has computing capability to perform the partial AI/ML model training but does not have AI/ML model training input data and AI/ML model training output data, in accordance with embodiments of the present disclosure;

FIGS. 11A and 11B illustrate two examples of training a learning block where AI/ML model training input and output data are in different nodes, in accordance with embodiments of the present disclosure;

FIG. 12 illustrates an example that a UE receives kernelized AI/ML model training input data and kernelized AI/ML model training output data from another UE by sidelink, in accordance with embodiments of the present disclosure; and

FIG. 13 illustrates an example procedure for training an artificial intelligence or machine learning (AI/ML) model in a communication network, in accordance with embodiments of the present disclosure.

Similar reference numerals may have been used in different figures to denote similar components.

### DETAILED DESCRIPTION

In the present disclosure, “HSIC block”, “Hilbert-Schmidt independence criterion block”, and “learning block” may refer to a number of successive neural layers that will be trained together on a computation node (a node that performs computations for AI/ML model training). Either forward-propagation only (FO) or backpropagation (BP) may be utilized for training within one HSIC block.

In the present disclosure, “training samples input” and “xₖ” may refer to the k-th epoch of input training data samples.

In the present disclosure, “training samples output” and “yₖ” may refer to the k-th epoch of output training data samples.

In the present disclosure, “kernelized input” and “Xₖ” may refer to a matrix resulting from the k-th epoch of input training data samples xₖ by a given kernel function (Xₖ=ƒ(xₖ, θ)).

In the present disclosure, “kernelized output” and “Yₖ” may refer to a matrix resulting from the k-th epoch of output training data samples yₖ by a given kernel function (Yₖ=g(yₖ, θ)).

In the present disclosure, “forward output from HSIC block i” and “T_{i,k}” may refer to the forward output from the HSIC block i in the k-th epoch.

In the present disclosure, HSIC criteria at the i-th HSIC block at the k-th epoch (L_{i,k}) may be obtained as follows: L_{i,k}=I_{HSIC} (Xₖ, T_{i,k})−βI_{HSIC}(Yₖ, T_{i,k}).

In the present disclosure, modified HSIC criteria at the i-th HSIC block at the k-th epoch may be obtained as follows: L_{i,k}= [symbol] (Xₖ; T_{i,k})−β [symbol] (Yₖ; T_{i,k})+γ [symbol] (T_{i,k}; T_{i,k}).

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

### Example Communication Systems and Devices

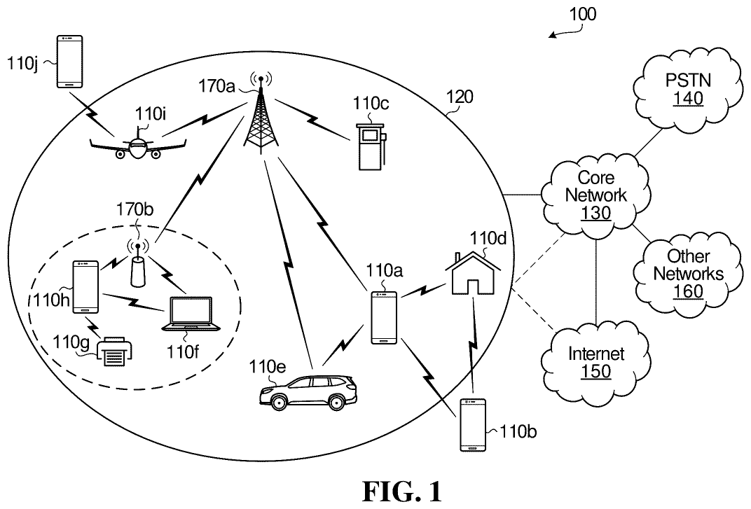

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

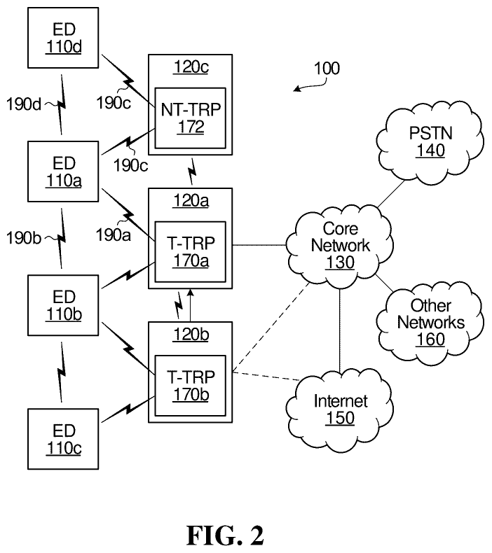

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

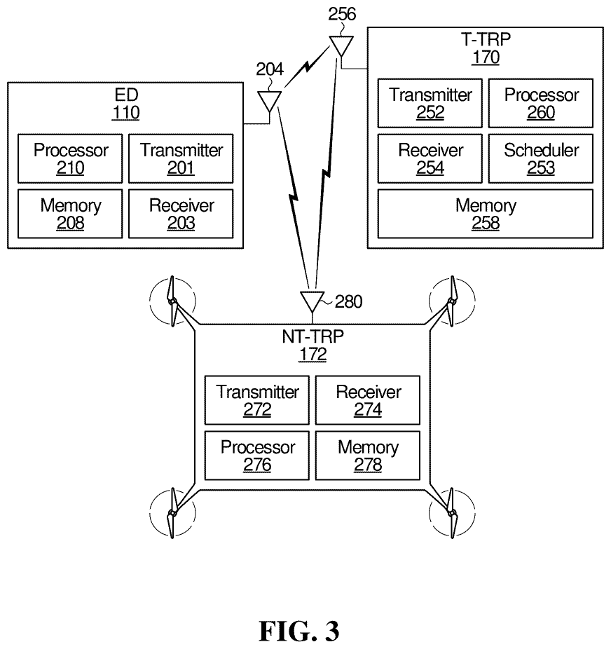

FIG. 3 illustrates another example of an ED no and a base station 170. The ED no is used to connect persons, objects, machines, etc. The ED no may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED no represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs no may be referred to using other terms. The base station 170a and 170b is a T-TRP and will hereafter be referred to as T-TRP 170. Also shown in FIG. 3, a NT-TRP will hereafter be referred to as NT-TRP 172. Each ED no connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

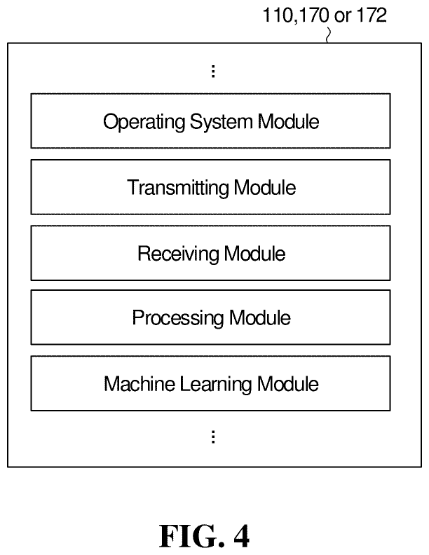

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in an mmWave band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0-5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

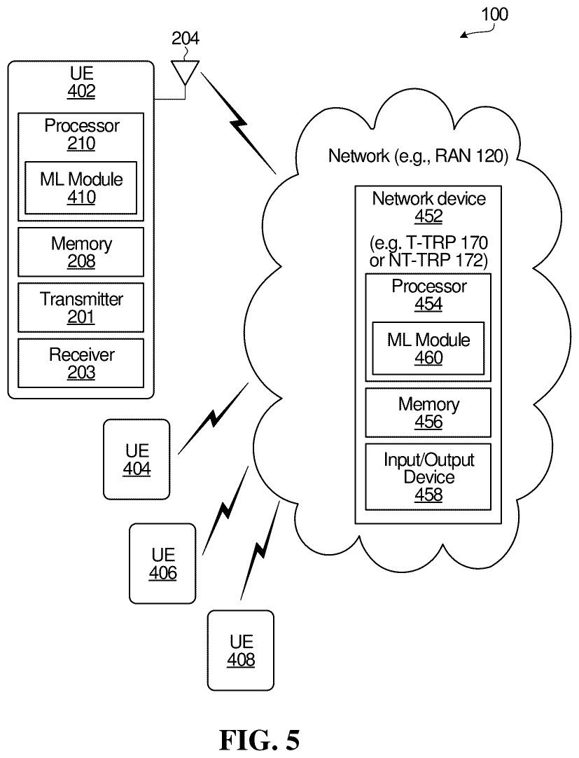

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 452 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc.). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation (or may be also referred to as backward propagation) is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

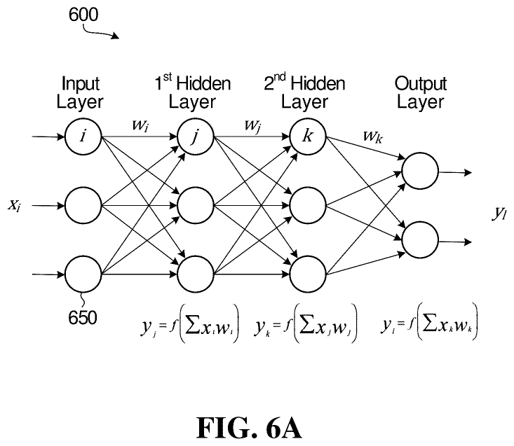

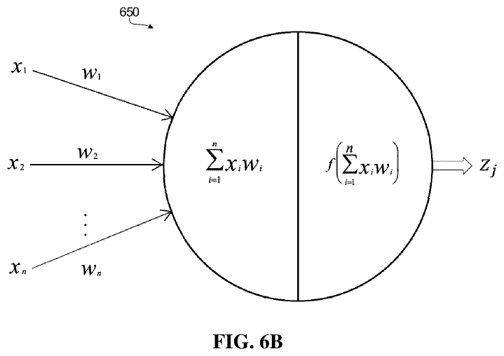

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function ƒ( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation (or may be also referred to as backward propagation) is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

Referring again to FIG. 5, for wireless federated learning (FL), the network device 452 may initialize a global AI/ML model implemented by the ML module 460, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria and the AI/ML model is finalized.

To train a DNN (otherwise referred as an AI/ML model or DNN model) to perform a particular task, such as a computer-vision task on images, a natural language processing task on text, a speech processing task on speech signals, or any other machine learning task, a training data set, one or more training objectives (e.g., goals, targets), and computation training resources may be required. Information about a DNN model, for example information related to an architecture and a set of hyperparameters of the DNN, may be also required.

The information about a DNN model may, for example, specify a number of layers in the DNN. The information about a DNN model may, for example, specify an activation function computed at the neurons of each layer of the DNN. A layer may, for example, be a convolutional layer, a normalization layer, (maximum) pooling layer, or a fully connected layer, or any other type of suitable layer. The deepest DNN models may include hundreds of layers, which may comprise hundreds of features. In some implementations, a DNN model may include a large quantity of neurons (e.g., billions of neurons). An architecture of a DNN model may be considered highly valued intellectual property. This may stem from consideration that some DNN architectures are more effective than others in that a DNN model may be trained more accurately and converged faster.

A training data set may include input data set (X) and an output label data set (Y). The input data set X may include multiple input data samples (x) related to the task being performed by the DNN model. For example, if the DNN model performs a computer-vision task, each input data sample is an image or a video. If DNN model performs a natural language processing task, each input data sample may be a one-hot representation of a word from a dictionary comprising K-words. The input data samples x may include any type of data such as text, images, video, etc. The output label data set Y may be referred to as output label data set and include multiple output label data samples (e.g., ground truth labels, output labels), with each output label data sample y (e.g., ground truth label) corresponding to one input data sample in the input data set X.

The input data set X may be organized into random batches of training data, with each batch of training data containing a number (e.g., m) of input data samples obtained from input data set X. The output label data set Y may be organized into batches corresponding to the input data set X. As such, the output label data sample (e.g., ground truth label, output data label) obtained from the output label data set Y may correspond to the input data samples obtained from input data set X. So-called “high quality” input data samples may feature thousands of dimensions. The raw input data set X may be considered private property and the output label data set Y may be considered highly valued intellectual property. This may stem from a consideration that procedures, such as labelling of input data samples and cleaning of input data samples, are expensive and critical to the overall performance of a trained DNN model.

A DNN model may be trained to fulfill one or more training objectives (which may also be referred to training goals or training targets or training tasks). For one example, a training objective for a DNN model which performs image classification may be established as being related to minimizing cross-entropy loss. For another example, a training objective for a DNN model which is an autoencoder may be established as being related to minimizing a square error. A training objective may be considered user-specific private property. Given the same training data set, distinct users may train a DNN model distinctly based on their distinct training objectives. The distinct training objectives may be understood to be closely aligned with the commercial interests of the distinct users.

One of computation resources mostly commonly used by a computing system to train a DNN model may be a graphical processing unit (GPU). The most common method of training a DNN model may involve optimizing parameters of the DNN model by using stochastic gradient descent (SGD) during backpropagation to compute updates for the parameters of the DNN model. In a method of training a DNN model that involves use of SGD to optimize the parameters of the DNN model, gradients may be determined for a batch of input data samples x, and corresponding output label data sample y (e.g., ground truth label) obtained from a training dataset. The method of training may include bi-directional propagation of a batch of training data from a training dataset. The first pass of the bi-directional propagation may be forward propagation (FP), during which an inference result 9 is determined based on an inference computation using an input data sample x in a batch of training data. The inference result 9 may be compared to the corresponding output label data sample y that corresponds to the input data sample x in the batch of training data, and a loss (otherwise referred to as an error) may be computed based on a loss function. After computing the error (e.g., loss) for the batch of training data, the second pass of the bi-directional propagation, which is backpropagation (BP), may be performed. The BP may be performed to adjust (or otherwise referred to as update) the parameters (e.g., weights and biases) of the DNN model, so that the computed loss function becomes smaller. BP may be performed to reduce the error (e.g., loss) between the inference results y generated by the DNN model and the output label data sample y (e.g., ground truth label) that correspond to the input data samples x in the batch of training data. Computing the gradients during BP involves using the chain rule.

Subsequent FP(s) and BP(s) are conventionally performed in an alternating pattern (e.g., FP→BP→FP→BP . . . ) for each batch of training data due to their data dependencies and sequential nature. It may be shown that cost, in terms of computation resources (e.g., memory and processing resources), of computing gradients during BP is much higher than the cost, in terms of computation resources, of performing the inference computations during FP. For very deep DNN models, hundreds or thousands of GPU cores may be required to perform training of a DNN model in which SGD is used to optimize the parameters of the DNN model.

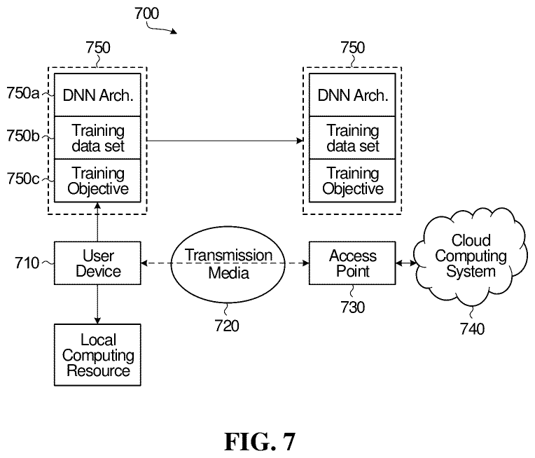

Newer DNN models are known to be larger and deeper than previously known DNN models. Consequently, newer DNN models may require more computation resources (e.g., memory and processing resources) than computation resources available on one or two local computing systems, which might have been sufficient for training previously known DNN models. As such, most DNN models may be trained now using computation resources provided by, for example, a cloud computing system, assuming that the cloud computing system has sufficient computation resources for training the DNN model. A user device (e.g., ED 110) with a DNN model having a particular architecture, a training dataset for training the DNN model and a training goal for the DNN model may not have access to sufficient computation resources to train the DNN model. To benefit from powerful remote computing systems, such as a cloud computing system, the user device may be expected to transmit, to the remote computing system, all the specifications of the DNN model to be trained, including the architecture of the DNN, the training dataset, and the training objective, as illustrated in FIG. 7.

Referring to FIG. 7, in a communication network 700, a DNN model in a user device 710 is expected to be trained to optimize the parameters of the DNN model. However, due to insufficient local computing resources in the user device 710, the DNN model may need to be trained using a cloud computing system 740 (which may be also referred to as a remote computing system 740) with sufficient computation resources. The cloud computing system 740 may have a large number of GPUs (e.g., thousands of GPUs or more) that may be available for the DNN model training. Accordingly, the user device 710 may transmit, to the cloud computing system 740, information about the DNN model 750 such as an architecture 750a of the DNN model, a training dataset 750b used for the DNN model training, and a training objective 750c for the DNN model. The DNN model information 750 may be user-specific data. The DNN model information 750 may be stored at the user device 710 or obtained by the user device 710. The user device 710 may transmit the DNN model information 750 to the clouding computing system 740 through an access point 730 (e.g., base station) which may be operatively and communicatively connected to the cloud computing system 740. In other words, the user device 710 may transmit the DNN model information 750 to the access point 730, and the access point 730 may transmit the received DNN model information 750 to the cloud computing system 740. The transmission media 720 between the user device 710 and the access point 730 may be wireless, wired, or a mix of wireless and wired. Given that the DNN model information 750 transmitted to the cloud computing system 740 may be private and user-specific, the user device 710 may be expected to trust the cloud computing system 740 and grant the cloud computing system 740 full authorization to manipulate its intellectual property (e.g., DNN model information 750 including the architecture of the DNN model, the training dataset used to train the DNN model, and the training objective for the DNN model). In some implementations, given that the DNN model information 750 may be transmitted to the cloud computing system 740 via the access point 730, the user device 710 may be expected to trust the access point 730, to a certain extent.

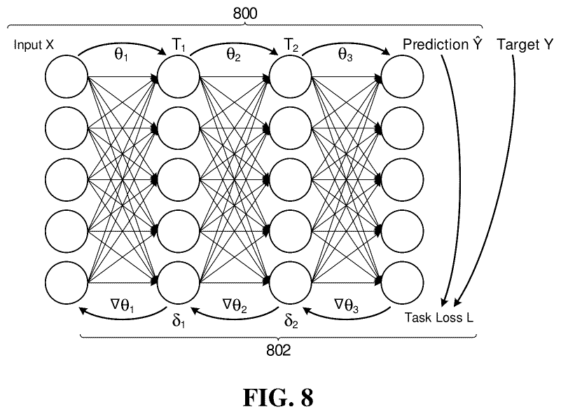

In the traditional method of training an AI/ML model, nodes that perform computations for AI/ML model training, which may be referred to as computation nodes, may use a BP algorithm to adjust or update parameters (e.g., weights, biases) in the neural network. A few issues may be identified in the traditional method of training an AI/ML model using the BP algorithm. One of the issues may be related to non-modular nature of the BP algorithm. Put another way, in the traditional method of training an AI/ML model using the BP algorithm, computation nodes (e.g., user equipment (UE), base station) may be expected to train a full AI/ML model and cannot perform a partial AI/ML model training. Another issue may be related to resources required to perform the AI/ML model training using the BP algorithm. Given that a full AI/ML model training may be expected using the BP algorithm, all parameters of the AI/ML model may need to be buffered in memory during the AI/ML model training process. Consequently, huge amount of memory and superior computation capacity may be required, and a long training delay may be expected. A further issue may relate to perceived low efficiency of the AI/ML model training that involves a BP algorithm. The sequential nature of the BP algorithm may cause difficulty in building a versatile high-throughput computing pipeline or good pipelining prospects. As shown in FIG. 8, the BP algorithm involves both a forward propagation pass 800 and a backpropagation pass 802. The backpropagation pass 802 may be also referred to as backward propagation pass 802. Accordingly, the conventional AI/ML model training that involves the BP algorithm may require many sequential steps to complete the AI/ML model training. For example, in FIG. 8, seven (7) sequential steps are needed to complete one epoch of the AI/ML model training involving the BP algorithm, although there are only 4 layers (i.e., one input layer, one output layer, two hidden layers).

As newer AI/ML models may be larger, deeper, and more complex than previously known AI/ML models, newer AI/ML models may require more computation resources (e.g., memory and processing resources). As such, learning nodes or computation nodes, such as UE and base station (e.g., TRP, BTS, relay, etc.), may not be able to provide sufficient resources to perform a full AI/ML model training. Accordingly, an air interface framework that supports partial AI/ML model training may be desired.

To address the above-identified issues, proposals have been made for methods and apparatuses for training a DNN using a forward-propagation-only (FO) algorithm. The proposed methods may involve training a Hilbert-Schmidt independence criterion (HSIC) block, using an FO algorithm, based on kernelized input data (Xₖ), kernelized output data (labels) (Yₖ), data acquired from a preceding layer before the HSIC block (T_{i-1,k}), and/or a loss function (L_{i,k}).

The kernelized input data Xₖ may be acquired based on AI/ML model training input data and a kernel function for the AI/ML model training input data ƒ(xₖ, θ). In other words, Xₖ=ƒ(xₖ, θ). The kernel function for the AI/ML model training input data ƒ(xₖ, θ) may be a Gaussian function, a cosine function, an inverse multiquadratic (IMQ) function, any combination thereof, or any other suitable function.

The kernelized output data (labels) Yₖ may be labelled data samples. The kernelized output (labels) Yₖ may be acquired based on AI/ML model training output data and a kernel function for the AI/ML model training output data g(yₖ, ϕ). In other words, Yₖ=g(yₖ, ϕ). The kernel function for the AI/ML model training output data g(yₖ, ϕ) may be a Gaussian function, a cosine function, an inverse multiquadratic (IMQ) function, any combination thereof, or any other suitable function. The kernel function for the AI/ML model training output data g(yₖ, ϕ) may be same as or different from the kernel function for the AI/ML model training input data ƒ(xₖ, θ).

The data acquired from a preceding layer before the HSIC block (T_{i-1,k}) may be an output of a layer preceding to the HSIC block. This data may be used by a computation node when calculating an output of the HSIC block (T_{i,k}).

The loss function (L_{i,k}) may be defined as L_{i,k}=I_{H}SIC (Xₖ, T_{i,k})−βI_{HSIC}(Yₖ, T_{i,k}), where I_{HSIC}( ) is the mutual information represented by HSIC, β is a parameter to control the balance of information bottleneck objectives. In some implementations, a modified HSIC loss function may be used. The modified HSIC loss function may be L_{i,k}= [symbol] (Xₖ; T_{i,k})−β [symbol] (Yₖ; T_{i,k})+γ [symbol] (T_{i,k}; T_{i,k}), where [symbol] ( ) is the mutual information represented by HSIC, β and γ are parameters to control the balance of information bottleneck objectives.

Aspects of the present disclosure provide specific methods and apparatuses for training an artificial intelligence or machine learning (AI/ML) model to support deep neural network (DNN)-based applications and DNN-based services in a communication network, which may be wireless, wired, or a mix of wireless and wired. In some aspects of the present disclosure, air interfaces in a communication network may be provided to support AI/ML model training methods using an FO algorithm. The AI/ML model training methods may support flexible partial AI/ML model training (e.g., allow a user equipment (UE) to train part of an AI/ML model flexibly) based on, for example, network configuration, computing power of the UE, and/or buffer capacity of a UE. The AI/ML model training methods illustrated below or elsewhere in the present disclosure may support various cases such as, for example, when a UE has training data and learning capability, when a UE has training data but does not have learning capability, and other cases.

According to some aspects of the present disclosure, an AI/ML model or a partial AI/ML model may be trained using training configuration information. The partial AI/ML model may be a learning block that includes a subset of less than all layers of the (full) AI/ML model. The training configuration information may be configured or determined based on at least one of capability of a UE performing the AI/ML model training (e.g., computation capability, buffer size, a power capacity), task requirement for a UE performing the AI/ML model training, network capacity (e.g., available network resources to be scheduled or used for a UE to report AI/ML model training results), or wireless link quality between a BS and a UE. According to some aspects, learning blocks may be dynamically switched during the AI/ML model training.

According to some aspects of the present disclosure, an AI/ML model training mode may be configured. The AI/ML model training mode may indicate whether whole of an AI/ML model (e.g., full AI/ML model) is to be trained or only part of the AI/ML model (e.g., partial AI/ML model) is to be trained.

According to some aspects of the present disclosure, incremental learning (continual learning) may be adopted to refine an AI/ML model. A partial AI/ML model may be refined via incremental learning. The incremental learning may be enabled based on HSIC loss of the learning block or loss convergence status of the learning block reported by a UE performing the AI/ML model training.

As illustrated below or elsewhere in the present disclosure, a general procedure of training a (partial) AI/ML model using a configurable FO algorithm may include an initialization stage and training stage. In the initialization stage, an architecture of the layer(s) of the DNN within the learning block (e.g., i-th HSIC block) may be configured, such as a number of layers and a number of neurons on the layer(s) within the learning block. The optimization criteria (e.g., HSIC loss or modified HSIC loss), optimization method (e.g., BP algorithm on stochastic gradient or FO algorithm), kernel functions (e.g., ƒ(xₖ, θ) and g(yₖ, ϕ) if raw data is passed into the computation node such as a UE) may be configured in the initialization stage. Which UE (computation node) or BS may participate in the AI/ML model training may be configured in the initialization stage as well.

In the training stage, input for the learning block (e.g., i-th HSIC block at the k-th epoch) may be obtained from a preceding layer before the learning block (e.g., the input for learning block i may be the output, T_{i-1,k}, of preceding learning block i−1). The AI/ML model training input data samples (xₖ) for the learning block may be received, for example by the UE, and kernelized AI/ML model training input data (Xₖ=ƒ(xₖ, θ)) may be computed using the received AI/ML model training data samples (xₖ). Similarly, the AI/ML model training output data samples (yₖ) for the learning block may be received, for example by the UE, and kernelized AI/ML model training output data (Yₖ=g(yₖ, θ)) may be computed using the received AI/ML model training output data samples (yₖ). In some embodiments, instead of computing, the kernelized AI/ML model training input and output data (Xₖ, Yₖ) may be received, for example by the UE. Then, the learning block may be trained, for example by the UE, to optimize the HSIC criteria, and the output (T_{i,k}) of the learning block may be transmitted, for example to the BS.

Some embodiments of the present disclosure may provide a configurable partial AI/ML model and configurable partial AI/ML model training and reporting. The configurable partial AI/ML model may be trained using training configuration information received from a base station (BS). After training, one or more parameters associated with the configurable partial AI/ML model may be transmitted by a user equipment (UE) to the BS. In some embodiments, a partial AI/ML model may be a learning block that includes one or more successive layers of the AI/ML model. The one or more successive layer of the AI/ML model may be a subset of less than all layers of the (full) AI/ML model. In some embodiments, the one or more successive layers of the AI/ML model may be trained together. The configurable partial AI/ML model training and reporting may be performed in various manners depending on, for example, location of the AI/ML model training data and computing capability of the computation node (e.g., UE), as illustrated below or elsewhere in the present disclosure.

In some embodiments in which a UE has AI/ML model training input data and AI/ML model training output data (e.g., xₖ, yₖ, Xₖ, Yₖ) and computing capability to perform the partial AI/ML model training, the UE may transmit to a BS information indicative of computing capability of the UE. The information indicative of computing capability of the UE may include the maximum number of floating point operations per second (FLOP), buffer size, or both. In some embodiments, the UE may further transmit to the BS i) an indication that the UE has AI/ML model training input data and AI/ML model training output data, and ii) information indicative of the amount of the AI/ML model training input data and AI/ML model training output data. It may be noted that the AI/ML model training output data may be data labels of the AI/ML model training input data.

After transmitting information related to the computing capability (and potentially AI/ML model training data as well), the UE may receive the training configuration information, for example, from the BS. The UE may train the learning block using the received training configuration information. The UE may determine the subset of layers of the (full) AI/ML model based on the training configuration information. In other words, the learning block may be determined based on the training configuration information.

After determining the learning block based on the training configuration information, the UE may train the learning block using AI/ML model training data. The AI/ML model training data may be generated by the UE or received from the BS or another UE. When the learning block training is completed, one or more parameters (e.g., weights, biases) of the AI/ML model may be adjusted, updated, or maintained without any changes in values. After training the learning block, the UE may transmit, to the BS, one or more parameters associated with the learning block. It may be noted that only parameters associated with the learning block may be transmitted to the BS. In other words, parameters of the AI/ML model that are not associated with the learning block may not be transmitted to the BS after the learning block training.

In some embodiments, the training configuration information may include an explicit indication of the learning block (to be trained), such as information indicative of the first and last layers of the learning block. For example, if the learning block is K^{th} layer to (K+n)^{th} layer of the (full) AI/ML model, at least one of K or n may be indicated in the training configuration information via radio resource control (RRC) signaling, media access control-control element (MAC-CE) signaling, or downlink control information (DCI) signaling. The values of K and n may be separately indicated or jointly indicated in the training configuration information. The UE may determine the learning block based on the values of K and n indicated in the training configuration information.

In some embodiments, the training configuration information may include an AI/ML model training pattern. The AI/ML model training pattern may indicate a plurality of blocks in the AI/ML model and a number of iterations for each block. For example, the BS may configure and transmit an AI/ML model training pattern to the UE. The AI/ML model training pattern may comprise {block i, Nᵢ iterations}, {block i+1, Nᵢ₊₁ iterations}, . . . , and {block i+k, Nᵢ₊ₖ iterations}. This training pattern may indicate that the block i is trained for Nᵢ iterations, and after Nᵢ iterations of the block i training, the next block i+1 is trained for Nᵢ₊₁ iterations, . . . , and after Nᵢ₊ₖ₋₁ iterations of the block i+k−1 training, the block i+k is trained for Nᵢ₊ₖ iterations. As such, relying on the AI/ML model training pattern, the UE may determine the learning block for a certain training iteration, by identifying layers of the learning block to be trained in that training iteration. In some embodiments, the AI/ML model training pattern may be configured by a BS and transmitted to the UE via RRC signaling, MAC-CE signaling, or DCI signaling.

In some embodiments, the training configuration information may not include the explicit indication of the learning block or the AI/ML model training pattern. In such cases, the learning block may be implicitly determined by the UE. In some embodiments, the UE may determine the learning block according to at least one of computing or processing capability of the UE, a power capacity of the UE, power saving requirement of the UE, a buffer size supported by the UE, an AI/ML model size supported by the UE, an AI/ML model complexity supported by the UE, latency requirement of the UE, or task latency requirement for the UE to perform the AI/ML model training. For example, when the BS configures that the starting layer of the learning block is K^{th} layer of the AI/ML model (i.e., BS configures K), the value of n may be 1 when the UE is in power saving mode, and the value of n may be 2 when the UE is in regular power consumption mode. The value of n indicates the ending layer of the learning block, as the ending layer of the learning block is (K+n)^{th} layer of the AI/ML model.

In some embodiments, the training configuration information may include information related to one or more preceding layers to the learning block. The preceding layers are subset of less than all layers of the AI/ML model. The information related to the preceding layers may be used to calculate the AI/ML model training input data for the learning block. In some embodiments where forward-propagation-only (FO) training is supported, the UE may train the learning block and update parameters associated with the learning block using HSIC. In some embodiments where forward-propagation-only (FO) training is not supported, the UE may train the learning block (e.g., K^{th} to (K+n)^{th} layers of the AI/ML model) using BP (backpropagation) algorithm. When using the BP algorithm, all layers preceding to the learning block (e.g., 1^{st} to (K−1)^{th} layers) may be frozen. In this way, the UE may train only the K^{th} layer to the last layer of the AI/ML model using the BP algorithm. However, the UE may only transmit, to the BS, parameters associated with the learning block. In other words, the UE may not transmit, to the BS, parameters associated with (K+n+1)^{th} to the last layers of the AI/ML model.

In some embodiments, the training configuration information may include kernel functions for AI/ML model training input data and AI/ML model training output data. The kernel functions for AI/ML model training input data and AI/ML model training output data may be expressed as ƒ(xₖ, θ) and g(yₖ, ϕ), respectively. The kernel function for AI/ML model training input data ƒ(xₖ, θ) may be a Gaussian function, a cosine function, an inverse multiquadratic (IMQ) function, any combination thereof, or any other suitable function. Similarly, the kernel function for AI/ML model training output data g(yₖ, ϕ) may be a Gaussian function, a cosine function, an IMQ function, any combination thereof, or any other suitable function.

In some embodiments, the learning block that is being trained may be dynamically switched during the AI/ML model training. Put another way, when a UE finish training one learning block, the UE may start training another learning block (i.e., switched to train another learning block), for example when the UE receives an indication to switch the learning block. Each learning block may be trained sequentially one after another.

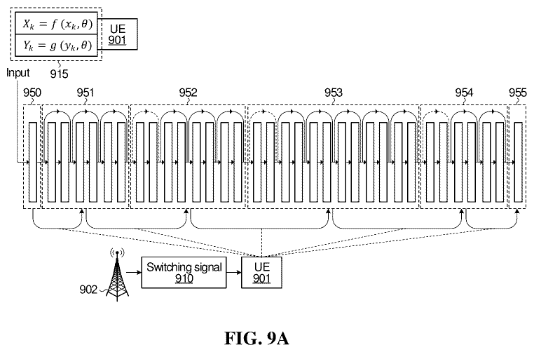

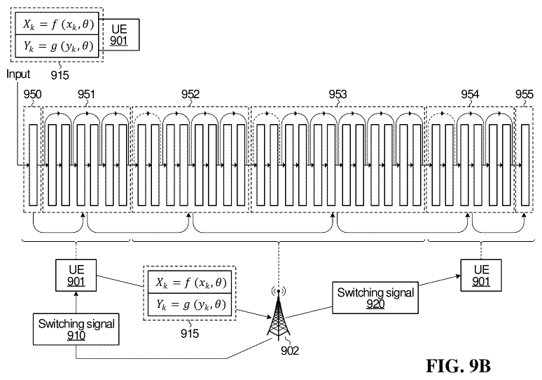

An example of learning block switching is illustrated in FIG. 9A. In FIG. 9A, a plurality of HSIC blocks are configured, and configuration information for these HSIC blocks are transmitted to the UE 901. It may be noted that an identifier (may be referred to as HSIC block identifier or learning block identifier) 950 to 955 is assigned to each HSIC block, as shown in FIG. 9A. In some embodiments, the configuration information for the plurality of HSIC blocks and the learning block identifiers 950 to 955 assigned to the HSIC blocks may be part of the training configuration information transmitted to the UE 901. The UE 901 may have AI/ML model training data 915 comprising kernelized AI/ML model training input data (Xₖ=ƒ(xₖ, θ)) and kernelized AI/ML model training output data (Yₖ=g(yₖ, θ)).

The UE 901 may start training the HSIC block 950 using the AI/ML model training data 915 and the training configuration information. After the UE 901 performs training of the block 950, the UE 901 may receive a switching signal 910 from the BS 902. In some embodiments, the BS 902 may determine whether the training of the block 950 is finished. For example, the BS 902 may determine the training of the block 950 is finished when loss for the block 950 is smaller than a certain threshold. For that, the UE 901 may transmit to the BS 902 at least one of an indication for loss of one or more layers in the HSIC block 950 or an indication for updating parameters associated with the HSIC block 950. When the BS 902 determines the training block switching, the switching signal 910 may be transmitted to the UE 901 via RRC signaling, MAC-CE signaling, or DCI signaling. In some embodiments, the switching signal 910 may be transmitted to the UE 901 via event signaling which indicates completion of training of the block 950. When the UE 901 receives the switching signal 910, the UE 901 may start training the HSIC block 951 (i.e., switched to train the HSIC block 951). The UE 901 may start training the HSIC block 951 based on the HSIC block identifier included in the switching signal 910. After the training of the block 950, the switching signal 910 may include an identifier for the HSIC block 951.

After the UE 901 performs training of the block 951, the BS 902 may determine whether the training of the block 951 is finished in a similar manner illustrated above or elsewhere in the present disclosure, for example based on the indication for loss of one or more layers in the HSIC block 951 or an indication for updating parameters associated with the HSIC block 951 received from the UE 901. When the BS 902 determines the training block switching, the BS 902 may transmit a switching signal 910 to the UE 901 in a manner similar to the above. After the UE 901 receives the switching signal 910, the UE 901 may start training the HSIC block 952 (i.e., switched to train the HSIC block 952), as the switching signal 910 includes an identifier for the HSIC block 952.

Each of the other HSIC blocks 952 to 955 may be sequentially trained in a similar manner illustrated above or elsewhere in the present disclosure. In particular, when the UE 901 receives the switching signal 910 from the BS 902, the UE 901 may switch to train an HSIC block based on the block identifier included in the switching signal 910.

Another example of learning block switching is illustrated in FIG. 9B. FIG. 9B illustrates an example of learning block switching where the HSIC blocks 952 and 953 are trained at the BS 902 and the other blocks 950, 951, 954, and 955 are trained at the UE 901, according to embodiments of the present disclosure. In a similar manner illustrated above and in FIG. 9A, a plurality of HSIC blocks may be configured and configuration information for these HSIC blocks may be transmitted to the UE 901. Like in FIG. 9A, the UE 901 may have AI/ML model training data 915 comprising kernelized AI/ML model training input data (Xₖ=ƒ(xₖ, θ)) and kernelized AI/ML model training output data (Yₖ=g(yₖ, θ)).

Compared to FIG. 9A, in FIG. 9B, the BS 902 may indicate the UE 901 to report the AI/ML model training data 915 so that the BS 902 may perform some of the AI/ML model training. In the case illustrated in FIG. 9B, the BS 902 may train the HSIC blocks 952 and 953. In some embodiments, the kernelized AI/ML model training input data (Xₖ=ƒ(xₖ, θ)) and kernelized AI/ML model training output data (Yₖ=g(yₖ, θ)), not raw AI/ML model training data, may be transmitted in order to protect user privacy. In FIG. 9B, the UE 901 transmits the kernelized AI/ML model training input data (Xₖ=ƒ(xₖ, θ)) and kernelized AI/ML model training output data (Yₖ=g(yₖ, θ)). The manner that the UE 901 transmits the kernelized AI/ML model training input and output data in the example of FIG. 9B is illustrated below.

The training of the HSIC blocks 950 and 951 in the example of FIG. 9B may be performed in a manner similar to that illustrated above and FIG. 9A. After the UE 901 performs training of the block 951, the UE 901 may transmit the (updated) parameters of the HSIC block 951. When the BS determines the training of the block 951 is completed, for example when loss for the block 951 is smaller than a certain threshold, the BS 902 may transmit to the UE 901 an instruction for at least one of transmitting kernelized AI/ML model training input data (Xₖ=ƒ(xₖ, θ)) and kernelized AI/ML model training output data (Yₖ=g(yₖ, θ)), or suspending the AI/ML model training.

In some embodiments, the BS 902 may instruct the UE 901 to suspend the AI/ML model training via AI/ML model training deactivation signaling. In some embodiments, the BS 902 may instruct the UE 901 to suspend the AI/ML model training by including an unavailable block identifier in the instruction. For example, the BS 902 may transmit to the UE 901 a signal, which may be same as or similar to the switching signal described above, comprising an HSIC block identifier 956. As there is no HSIC block 956, the UE 901 may understand this as an instruction to suspend the AI/ML model training.

After transmitting the instruction for transmitting the kernelized AI/ML model training input and output data or suspending the AI/ML model training, the BS 902 may train the HSIC blocks 952 and 953 using the kernelized AI/ML model training input and output data received from the UE 901. When the training of the HSIC blocks 952 and 953 is completed, the BS 902 may transmit the switching signal 920 or an AI/ML model training activation signal to the UE 901. The switching signal 920 and the AI/ML model training activation signal may include an identifier of the HSIC block 954. In this way, the UE 901 may know the training of the HSIC blocks 952 and 953 are completed and may start training of the HSIC block 954. The training of the HSIC blocks 954 and 955 may be performed by the UE 901 in a manner similar to that described above or elsewhere in the present disclosure.

In some embodiments where a UE has computing capability to perform the partial AI/ML model training but does not have AI/ML model training input data and AI/ML model training output data (e.g., xₖ, Yₖ, Xₖ, Yₖ), the UE may receive, from a BS, kernelized AI/ML model training input data and kernelized AI/ML model training output data, and train the learning block using the kernelized AI/ML model training input and output data received from the BS. An example is provided in FIG. 10.

FIG. 10 illustrates an example of training a learning block 1010 (e.g., HSIC block 1010) where a UE 1001 has computing capability to perform the partial AI/ML model training but does not have AI/ML model training input data and AI/ML model training output data, in accordance with embodiments of the present disclosure. As shown in FIG. 10, the BS 1002 may transmit the kernelized AI/ML model training input data and kernelized AI/ML model training output data, collectively kernelized AI/ML model training data 1020, to the UE 1001. The BS 1002 may further transmit a partial AI/ML model before the learning block 1010 (i.e., preceding learning block 1009) or an output T_{i-1,k} of the preceding learning block 1009. It may be noted that the output T_{i-1,k} of the preceding learning block 1009 is an input of the learning block 1010.

In some embodiments, the preceding learning block 1009 may be transmitted to the UE 1001 through the training configuration information. Put another way, the training configuration information may include one or more parameters (e.g., weight, bias, structure) of the preceding learning block 1009. The UE 1001 may compute the output of the learning block 1010 using the parameters of the preceding learning block 1009 and the kernelized AI/ML model training data 1020 received from the BS 1002.

In some embodiments, the output T_{i-1,k} of the preceding learning block 1009 may be transmitted to the UE 1001 through the training configuration information. Put another way, the training configuration information may include the output T_{i-1,k} of the preceding learning block 1009. The UE 1001 may compute the output of the learning block 1010 using the output T_{i-1,k} of the preceding learning block 1009 and the kernelized AI/ML model training data 1020 received from the BS 1002.

In some embodiments, the parameters of the preceding learning block 1009 and the output T_{i-1,k} of the preceding learning block 1009 may be part of the information related to the one or more preceding layers included in the training configuration information.

In some embodiments, the training configuration information may include the kernelized AI/ML model training data 1020.

It may be noted that the training configuration information discussed in connection to FIG. 10 may further include other data as discussed above with reference to other embodiments in which a UE has AI/ML model training input data and AI/ML model training output data and computing capability to perform the partial AI/ML model training. For example, the training configuration information discussed in connection to FIG. 10 may further include at least one of information indicative of the first layer of the learning block, information indicative of the last layer of the learning block, the AI/ML model training pattern, a kernel function for AI/ML model training input data, or a kernel function for AI/ML model training output data.

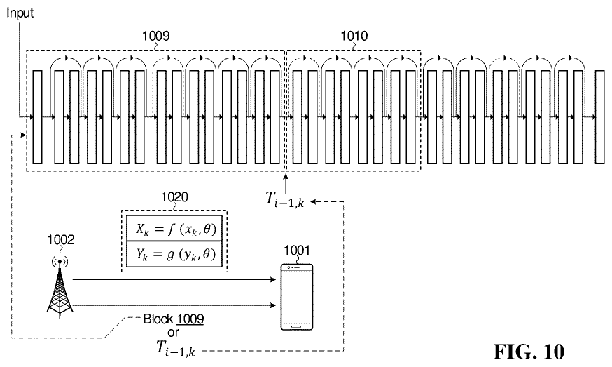

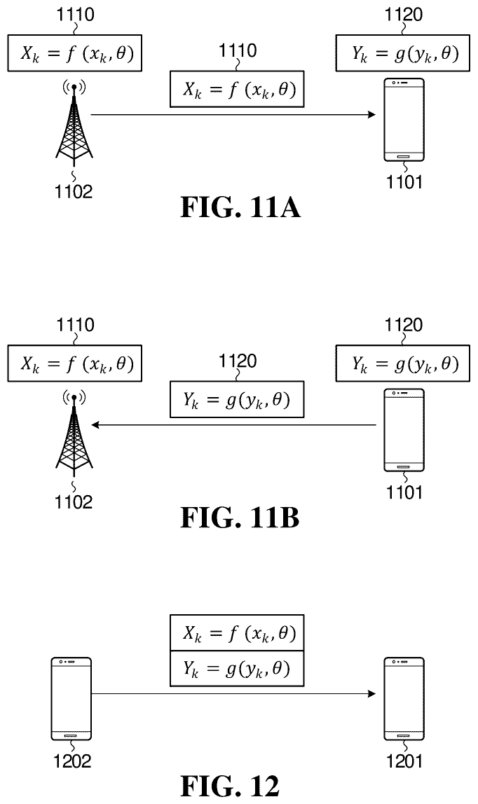

In some embodiments where AI/ML model training input data and AI/ML model training output data are in different nodes (e.g., located in a UE and a BS, respectively), the UE and the BS may exchange kernelized AI/ML model training input data or kernelized AI/ML model training output data. Two non-limiting examples are provided in FIGS. 11A and 11B.

FIGS. 11A and 11B illustrate examples of training a learning block where a UE 1101 has AI/ML model training output data 1120 but does not have AI/ML model training input data 1110, in accordance with embodiments of the present disclosure.

In FIG. 11A, a BS 1102 may send kernelized AI/ML model training input data 1110 (e.g., input data, Xₖ=ƒ(xₖ, θ)) to a UE 1101, epoch by epoch. The UE 1101 may train the learning block (not shown in FIG. 11A) using the kernelized AI/ML model training input data 1110 received from the BS 1102 and the kernelized AI/ML model training output data 1120 located at the UE 1101. In some embodiment, the BS 1102 may optionally transmit to the UE 1101 a kernel function for the AI/ML model training input data, a kernel function for the AI/ML model training output data, or both. The kernel functions may be included in the training configuration information.

In FIG. 11B, a UE 1101 may send kernelized AI/ML model training output data 1120 (e.g., output labels, Yₖ=g(yₖ, θ)) to a BS 1102, epoch by epoch. For that, in some embodiments, the BS 1102 may transmit, to the UE 1101, a kernel function for AI/ML model training input data, a kernel function for AI/ML model training output data, or both. The kernel functions may be included in the training configuration information. The UE 1101 may calculate the kernelized AI/ML model training output data 1120 using the AI/ML model training output data and the kernel function for the AI/ML model training output data. Then, the UE 1101 may transmit the kernelized AI/ML model training output data 1120 to the BS 1102. After receiving the kernelized AI/ML model training output data 1120, the BS 1102 may train the learning block (not shown in FIG. 11B) using the kernelized AI/ML model training output data 1120 received from the UE 1101 and the kernelized AI/ML model training input data 1110 located at the BS 1102.

In some embodiments where a UE has computing capability to perform the partial AI/ML model training but does not have at least one of AI/ML model training input data or AI/ML model training output data, the UE may receive at least one of kernelized AI/ML model training input data or kernelized AI/ML model training output data from another UE, as illustrated in FIG. 12.

FIG. 12 illustrates an example that a UE 1201 receives kernelized AI/ML model training input data and kernelized AI/ML model training output data from another UE 1202 by sidelink, in accordance with embodiments of the present disclosure. The UE 1201 may not have at least one of AI/ML model training input data or AI/ML model training output data. The UE 1202 may have computing capability to perform the partial AI/ML model training (learning block training). The UE 1202 may have AI/ML model training data and therefore transmit, to the UE 1201, at least one of kernelized AI/ML model training input data or kernelized AI/ML model training output data. The UE 1202 may transmit the kernelized AI/ML model training data by sidelink. In some embodiments, after the transmission of the training data, the UE 1202 or a BS (now shown in FIG. 12) may transmit to the UE 1201 an indication to start training the learning block (i.e., partial AI/ML model training). In some embodiments, the UE 1202 may transmit the indication to start the learning block training together with kernelized AI/ML model training input data and/or kernelized AI/ML model training output data.

In some embodiments where a UE has computing capability to perform the partial AI/ML model training and has only a small amount of AI/ML model training input data and AI/ML model training output data, the UE may receive additional AI/ML model training data from a BS. For example, the UE may report, to the BS, the amount of the AI/ML model training input data and the AI/ML model training output data. The UE may report, to the BS, before receiving the training configuration information from the BS. After receiving the amount of the AI/ML model training input and output data, the BS may determine whether the amount of the AI/ML model training input data and the AI/ML model training output data is enough for training the learning block. When the amount of the AI/ML model training input data and the AI/ML model training output data is not enough, for example less than a predetermined amount, the BS may transmit, to the UE, at least one of additional AI/ML model training input data and additional AI/ML model training output data, or additional kernelized AI/ML model training input data and additional kernelized AI/ML model training output data. It may be noted that the additional AI/ML model training output data is data labels of the additional AI/ML model training input data, and the additional kernelized AI/ML model training output data is data labels of the additional kernelized AI/ML model training input data. In some embodiments, the additional AI/ML model training input and output data and/or the additional kernelized AI/ML model training input and output data may be included in the training configuration information. The UE may produce improved results for the learning block training with the additional AI/ML model training input and output data and/or the additional kernelized AI/ML model training input and output data. In some embodiments, the UE may receive the additional AI/ML model training input and output data and/or the additional kernelized AI/ML model training input and output data from another BS or another UE.

In some embodiments where a BS has computing capability to perform the partial AI/ML model training and has a small amount of AI/ML model training input data and AI/ML model training output data, the BS may receive kernelized input and output data or additional kernelized input and output data from a UE or another BS. It may be considered that the BS has a small amount of AI/ML model training input and output data when the amount of the kernelized AI/ML model training input and output data is less than a predetermined amount. After receiving the kernelized AI/ML model training input and output data or the additional kernelized AI/ML model training input and output data, the BS may train the learning block using the kernelized AI/ML model training input and output data, and the additional kernelized AI/ML model training input and output data.

The kernelized AI/ML model training input and output data or the additional kernelized AI/ML model training input and output data may be generated by a node (e.g., the UE or the other BS) using AI/ML model training input and output data and the kernel functions for the AI/ML model training input and output data, or using additional AI/ML model training input and output data and the kernel functions for the additional AI/ML model training input and output data. The AI/ML model training output data may be data labels of the AI/ML model training input data, and the additional AI/ML model training output data may be data labels of the additional AI/ML model training input data.

The kernel functions may be predefined or may be configured by the BS. If the kernel functions are configured by the BS, the BS may transmit the configured kernel functions to the UE or the other BS that would transmit the kernelized AI/ML model training input and output data or the additional kernelized AI/ML model training input and output data. In some embodiments, the BS may transmit, to the UE, the kernelized functions through the training configuration information. In some embodiments, the BS may transmit, to the other BS, the kernel functions via an interface between these two BSs.

According to some embodiments, an AI/ML model training mode may be configured. The AI/ML model training mode may indicate whether whole of the AI/ML model (e.g., full AI/ML model) is to be trained or only part of the AI/ML model (e.g., partial AI/ML model) is to be trained. A UE may receive, for example from a BS, information indicative of an AI/ML model training mode. In some embodiments, the UE may train an AI/ML model or a partial AI/ML model (e.g., learning block) using both FO and BP algorithms. In some embodiments, the UE may receive the information indicative of the AI/ML model training mode via RRC signaling, MAC-CE signaling, or DCI signaling. Based on the received information (e.g., AI/ML model training mode), the UE may switch, keep, activate, and/or deactivate the AI/ML model training mode. When the UE activates the AI/ML model training mode, the UE may start training a partial AI/ML model (e.g., learning block) only using the forward propagation algorithm.

When the received AI/ML model training mode indicates whole of the AI/ML model is to be trained (for example using BP algorithm), the UE may provide AI/ML model training input data to the AI/ML model, then propagate to the output layer of the AI/ML model to generate AI/ML model training output data. The UE may calculate the loss of the AI/ML model training output data by comparing the labels of the AI/ML model training input data and the AI/ML model training output data. Then, the UE may backward-propagate the loss to the input layer of the AI/ML model (e.g., train the AI/ML model using the BP algorithm), and may obtain the gradient information for all layers of the AI/ML model.

When the received AI/ML model training mode indicates only part of the AI/ML model is to be trained, the UE may acquire a kernel function for the AI/ML model training input data and a kernel function for the AI/ML model training output data. The UE may transform the AI/ML model training input and output data (e.g., input data, labels) into kernelized AI/ML model training input and output data (Xₖ, Yₖ) using the acquired kernel functions. The UE may obtain an output of the partial AI/ML model (e.g., learning block) using the kernelized AI/ML model training input data (Xₖ) and the data acquired from a preceding layer before the partial AI/ML model. For example, the data acquired from a preceding layer before the partial AI/ML model may be an output (e.g., T_{i-1,k}) of a preceding learning block (e.g., learning block i−1) that is used as an input of the partial AI/ML model (e.g., learning block i). The UE may calculate the loss of the learning block i (e.g., gradient information) using the input of the partial AI/ML model (e.g., learning block i) and the kernelized AI/ML model training output data (Yₖ) and the FO loss function.

In some embodiments, the AI/ML model training mode may be configured and switched by a BS, for example via RRC signaling, MAC-CE signaling, or DCI signaling. Put another way, the UE may switch the AI/ML model training mode based on the information indicative of the AI/ML model training mode received from the BS via RRC signaling, MAC-CE signaling, or DCI signaling.

In some embodiments, the AI/ML model training mode may be implicitly determined based on an AI/ML model training stage. For example, in an early training stage, an AI/ML model may be trained using a BP algorithm to get a coarse AI/ML model. In late training stages, the AI/ML model may be trained using a FO algorithm to achieve AI/ML model convergence. In some embodiments, classification of early training stage and late training stage may be predefined or configured by a BS. For example, late training stages may be predefined or configured as training stages after N iterations (e.g., the value of N may be predefined or configured), or training stages having AI/ML model training loss less than a certain AI/ML model training loss threshold (e.g., the AI/ML model training loss threshold is predefined or configured). When the loss of the AI/ML model is smaller than a certain threshold, the UE may be switched to use the FO algorithm when further training the AI/ML model.

In some embodiments, the AI/ML model training mode may be implicitly determined based on capability of the UE, such as a power capacity of the UE, a buffer size supported by the UE, an AI/ML model size supported by the UE, an AI/ML model size supported by the UE, and an AI/ML model complexity supported by the UE. For example, when the capability of the UE is lower than a certain threshold, the UE may be switched to train the AI/ML model using the FO algorithm. Otherwise, the UE may train the AI/ML model using a BP algorithm.

In some embodiments, the AI/ML model training mode may be implicitly determined based on power saving requirement of the UE. For example, when the UE is in a power saving mode, the UE may train the AI/ML model using the FO algorithm. When the UE is in a regular power mode, UE may train the AI/ML model using a BP algorithm.

In some embodiments, the AI/ML model training mode may be implicitly determined based on processing capability of the UE, in particular processing capability for AI/ML model training. For example, when the UE is performing sensing calculation, the processing capability for AI/ML model training may be reduced. When the processing capability for AI/ML model training is less than a certain threshold, the UE may train the AI/ML model using a FO algorithm. Otherwise, the UE may train the AI/ML model using a BP algorithm.

When performance of an AI/ML model is not great (e.g., loss is greater than a certain threshold) during model monitoring or model training procedure, the whole AI/ML model had to be trained and refined, according to existing AI/ML model training methods. In contrast, according to some embodiments of the present disclosure, only partial AI/ML model may be refined using incremental learning (continual learning), thereby reducing AI/ML model training delay and reporting overhead. The incremental learning may be enabled by an AI/ML model training using a FO algorithm. In some embodiments, the manner that the incremental learning or the AI/ML model training using a FO algorithm is performed is similar to that described above or elsewhere in the present disclosure, for example FIGS. 9A and 9B.

In some embodiments, a new measurement report may be defined to enable incremental learning. A UE may report, to a BS, an AI/ML model training loss for the learning block (e.g., i-th HSIC block) or loss convergence status of the learning block. The AI/ML model training loss may be a HSIC loss of the learning block. The loss convergence status of the learning block may indicate whether the AI/ML model training loss is decreasing during N iterations, or the AI/ML model training loss in the N iterations is below a certain threshold. It may be noted that the value of N may be predefined or configured by a BS. In some embodiments, the UE may report, to the BS, AI/ML model training loss or loss convergence status for one or multiple learning blocks.

In some embodiments where a BS determines the learning block (e.g., determines a starting layer of the learning block and an ending layer of the learning block), a UE may report, to the BS, an identifier (e.g., index) of the learning block and the loss of the learning block (or the loss convergence status of the learning block). In some embodiments, the identifier of the learning block may be configured by a BS.

In some embodiments where a UE determines the learning block (e.g., determines a starting layer of the learning block and an ending layer of the learning block), a UE may report, to a BS, information indicative of the learning block division (e.g., starting layer (K-th layer) of the learning block and the ending layer ((K+n)-th layer) of the learning block) and the loss of the learning block (or the loss convergence status of the learning block).

In some embodiments, the UE may receive, from the BS, information indicative of at least one of time resource, frequency resource, or spatial resource for reporting loss of the learning block or loss convergence status of the learning block via RRC signaling, MAC-CE signaling, DCI signaling, or event signaling indicating when to report the loss of the learning block or the loss convergence status of the learning block. For example, a BS may indicate, to a UE, the reporting timing and report resources via DL or UL DCI signaling. Then, the UE may use the resources indicated by the BS to report the loss of the learning block or the loss convergence status of the learning block at the time slot indicated by the BS. For another example, a BS may transmit, to a UE, an event configuration indicating that the UE is required to report the loss of the learning block or the loss convergence status of the learning block when one or more event conditions are satisfied. The one or more event conditions may be predefined or configured by a BS. The one or more event conditions may be considered to have been satisfied for example when the loss of the learning block or the loss convergence status of the learning block is greater than a certain threshold. When the one or more event conditions are satisfied, the UE may report the loss of the learning block or the loss convergence status of the learning block.

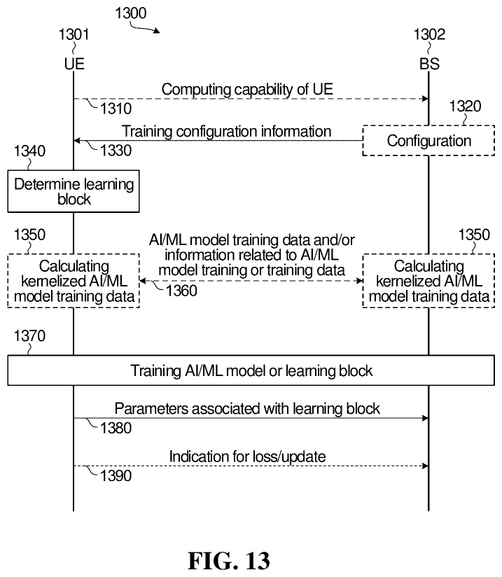

FIG. 13 illustrates an example procedure 1300 for training an artificial intelligence or machine learning (AI/ML) model in a communication network, in accordance with embodiments of the present disclosure. The example procedure 1300 comprises steps 1310 to 1390. It should be noted that some of steps 1310 to 1390 may be optional, and the order of one or more steps 1310 to 1390 may be changed.

A UE 1301 and a BS 1302 may communicate to each other and may be part of a communication network.

At step 1310, the UE 1031 may transmit, to the BS 1302, information indicative of computing capability of the UE 1301. Step 1310 may be optional.

At step 1320, the BS 1302 may configure at least one of a kernel function for AI/ML model training input data or a kernel function for AI/ML model training output data. The kernel function for the AI/ML model training input data and the kernel function for the AI/ML model training output data may be included in training configuration information that will be transmitted to the UE 1301 at step 1330. The BS 1302 may also configure some other information to be included in the training configuration information. Step 1320 may be optional.

At step 1330, the BS 1302 may transmit, to the UE 1301, training configuration information for a learning block. The learning block may include one or more successive layers of an AI/ML model which may be a subset of less than all layers of the AI/ML model. In some embodiments, the one or more successive layers of the learning block may be trained together.

In some embodiments, the training configuration information may comprise at least one of: information indicative of a first layer of the learning block, information indicative of the last layer of the learning block, an AI/ML model training pattern indicating a plurality of blocks in the AI/ML model and a number of iterations for each of the plurality of blocks, information related to one or more preceding layers to the learning block, a kernel function for AI/ML model training input data, or a kernel function for AI/ML model training output data. It should be noted that at least in some embodiments, the AI/ML model training output data may be one or more data labels of the AI/ML model training input data. In some embodiments, the information related to the one or more preceding layers may include one or more parameters associated with the one or more preceding layers, or an input of the learning block.

In some embodiments where the training configuration information does not comprise the kernel function for the AI/ML model training input data and the kernel function for the AI/ML model training output data, the kernel function for the AI/ML model training input data and the kernel function for the AI/ML model training output data may be predefined.

At step 1340, the UE 1301 may determine the learning block using the training configuration information received from the BS 1302. For example, the UE 1301 may determine the learning block based on information indicative of the first and last layers of the learning block included in the training configuration information.

At step 1350, the UE 1301, the BS 1302, or both may calculate at least one of kernelized AI/ML model training input data or kernelized AI/ML model training output data. Step 1350 may be optional.

In some embodiments, step 1350 may occur when the AI/ML model training input data and the AI/ML model training output data are in different nodes (e.g., the AI/ML model training input data is at the BS 1302 and the AI/ML model training output data is at the UE 1301). The node (UE 1301 or BS 1302) that receives the kernelized AI/ML model training data may perform training of the AI/ML model or the learning block at step 1370.

In some embodiments, the UE 1301 may calculate the kernelized AI/ML model training output data, using the AI/ML model training output data and the kernel function for the AI/ML model training output data. The kernelized AI/ML model training output data may be sent to the BS 1302 later for example at step 1360. In such cases, the BS 1302 may be the node that trains the AI/ML model or the learning block at step 1370.

In some embodiments, the BS 1302 may calculate the kernelized AI/ML model training input data, using the AI/ML model training input data and the kernel function for the AI/ML model training input data. The kernelized AI/ML model training input data may be sent to the UE 1301 later for example at step 1360. In such cases, the UE 1301 may be the node that trains the AI/ML model or the learning block at step 1370.

At step 1360, the UE 1301 and BS 1302 may exchange (i.e., transmit, receive, or both) at least one of AI/ML model training input data, AI/ML model training output data, kernelized AI/ML model training input data, or kernelized AI/ML model training output data. The UE 1301 and BS 1302 may also exchange information related to AI/ML model training or AI/ML model training data. Step 1360 may be optional.

In some embodiments, the UE 1301 may transmit, to the BS 1302, at least one of kernelized AI/ML model training input data or the kernelized AI/ML model training output data. In some embodiments, the BS 1302 may transmit, to the UE 1301 or another BS, AI/ML model training data to be used for training (e.g., at step 1370) the AI/ML model or the learning block.

In some embodiments, the UE 1301 may transmit, to the BS 1302, information indicative of at least one of (i) whether the UE 1301 has the AI/ML model training input data and the AI/ML model training output data, or (ii) amount of the AI/ML model training input data and the AI/ML model training output data. If the UE 1301 does not have the AI/ML model training input data and/or the AI/ML model training output data, the BS 1302 may transmit, to the UE 1301, kernelized AI/ML model training input data and/or kernelized AI/ML model training output data. If the UE 1301 does not have enough amount of the AI/ML model training input data and/or the AI/ML model training output data (e.g., the amount of the AI/ML model training input data and the AI/ML model training output data is less than a predetermined amount), the BS 1302 may transmit, to the UE 1301, at least one of (i) additional AI/ML model training input data and additional AI/ML model training output data, or (ii) additional kernelized AI/ML model training input data and additional kernelized AI/ML model training output data. The additional AI/ML model training output data may be data labels of the additional AI/ML model training input data.

While not explicitly described in FIG. 13, in some embodiments, the UE 1301 may receive, from another UE, at least one of kernelized AI/ML model training input data or kernelized AI/ML model training output data.

While not explicitly described in FIG. 13, in some embodiments where the BS 1302 does not have enough amount of kernelized AI/ML model training input data and/or kernelized AI/ML model training output data (e.g., the amount of the kernelized AI/ML model training input data and the kernelized AI/ML model training output data is less than a predetermined amount), the BS 1302 may transmit, to another BS, the kernel function for the AI/ML model training input data and the kernel function for the AI/ML model training output data. Then, the other BS may generate additional kernelized AI/ML model training input data and additional kernelized AI/ML model training output data using the received kernel functions. Then, the BS 1302 may receive, from the other BS, the additional kernelized AI/ML model training input data and the additional kernelized AI/ML model training output data.

In some embodiments, at step 1360, the BS 1302 may transmit, to the UE 1301, information indicative of an AI/ML model training mode. The AI/ML model training mode indicates whether whole of the AI/ML model is to be trained or only part of the AI/ML model is to be trained. The UE 1301 may switch, keep, or activate the AI/ML model training mode based on the information indicative of the AI/ML model training mode received from the BS 1302. The information indicative of the AI/ML model training mode may be transmitted to the UE 1301 via radio resource control (RRC) signaling, media access control-control element (MAC-CE) signaling, downlink control information (DCI) signaling. In some embodiments, the AI/ML model training mode may be determined based on at least one of an AI/ML model training stage, a power capacity of the UE 1301, a buffer size supported by the UE 1301, an AI/ML model size supported by the UE 1301, an AI/ML model complexity supported by the UE 1301, power saving requirement of the UE 1301, or processing capability of the UE 1301.

In some embodiments, at step 1360 or prior to step 1370, the BS 1302 may transmit, to the UE 1301, a switching signal to start training the learning block. The switching signal may comprise a learning block identifier assigned to the learning block. The switching signal may be transmitted to the UE 1301 via RRC signaling, MAC-CE signaling, DCI signaling, or event signaling indicating completion of a preceding learning block training. The BS 1302 may transmit the switching signal when a training for a preceding learning block is completed. In some embodiments, the BS 1302 may determine whether the training for the preceding learning block is completed based on the loss of the preceding learning block. For that, the UE 1301 may transmit, to the BS 1302, an indication for loss of at least one layer of the one or more successive layers of the preceding learning block. In some embodiments, the BS 1302 may determine that the training for the preceding learning block is completed when the BS 1302 receives, from the UE 1301, an indication for updating one or more parameters associated with the preceding learning block.

At step 1370, at least one of the UE 1301 or the BS 1302 may train the AI/ML model or the learning block using the training configuration information. At least in some embodiments, the UE 1301 may train the AI/ML model or the learning block using AI/ML model training data. In some embodiments, the AI/ML model training data may be generated by the UE 1301. In some embodiments, the AI/ML model training data may be received from the BS 1302 or another UE, as illustrated above or elsewhere in the present disclosure. In some embodiments, the learning block of the AI/ML model may be trained using a backpropagation algorithm, and the one or more preceding layers to the learning block may be frozen.

In some embodiments where the AI/ML model training mode indicates whole of the AI/ML model is to be trained, the UE 1301 may train the AI/ML model using at least one of a forward propagation algorithm or a backpropagation algorithm. In some embodiments where the AI/ML model training mode indicates only part of the AI/ML model is to be trained, the UE 1301 may train the learning block without using a backpropagation algorithm. In some embodiments where the UE 1301 activates the AI/ML model training mode based on the information indicative of the AI/ML model training mode, the UE 1301 may start training the learning block only using the forward propagation algorithm.

In some embodiments, the BS 1302 may train the learning block using the kernelized AI/ML model training input data and the kernelized AI/ML model training output data.

In some embodiments where the BS 1302 receives the additional kernelized AI/ML model training input data and the additional kernelized AI/ML model training output data because for example the amount of the kernelized AI/ML model training input data and the kernelized AI/ML model training output data is less than a predetermined amount, the BS 1302 may train the learning block using the kernelized AI/ML model training input data, the kernelized AI/ML model training output data, the additional kernelized AI/ML model training input data, and the additional kernelized AI/ML model training output data.

While not explicitly illustrated in FIG. 13, in some embodiments, the BS 1302 may transmit, to the UE 1301, an instruction for at least one of suspending the AI/ML model training or transmitting kernelized AI/ML model training input data and kernelized AI/ML model training output data. After receiving the instruction, the UE 1301 may suspend the AI/ML model training (e.g., AI/ML model training for a first preceding learning block), and then transmit the kernelized AI/ML model training input data and kernelized AI/ML model training output data. In some embodiments, the BS 1302 may perform the AI/ML model training (e.g., AI/ML model training for a second preceding learning block) using the kernelized AI/ML model training input data and kernelized AI/ML model training output data received from the UE 1301. After the AI/ML model training for the second preceding learning block, the BS 1302 may transmit, to the UE 1301, a switching signal to start training the learning block. The switching signal may comprise a learning block identifier assigned to the learning block. The switching signal may be transmitted to the UE 1301 via RRC signaling, MAC-CE signaling, DCI signaling, or event signaling indicating completion of a preceding learning block training.

At step 1380, the UE 1301 may transmit, to the BS 1302, one or more parameters associated with the learning block. The one or more parameters may be updated after the training at step 1370. In some embodiments, even if the UE 1301 trained the full AI/ML model at step 1370, the UE 1301 may transmit only parameters associated with the learning block, which may only include a subset of less than all layers of the AI/ML model.

At step 1390, the UE 1301 may transmit, to the BS 1302, information indicative of the loss of the learning block or the loss convergence status of the learning block, or an indication for updating one or more parameters associated with the learning block. Step 1390 may be optional. In some embodiments, the loss of the learning block may be loss of at least one layer of one or more successive layers of the learning block. In some embodiments where the BS 1302 determines a starting layer of the learning block and an ending layer of the learning block, the UE 1301 may transmit, to the BS 1302, an index of the learning block. In some embodiments where the UE 1301 determines a starting layer of the learning block and an ending layer of the learning block, the UE 1301 may transmit, to the BS 1302, information indicative of the starting layer of the learning block and the ending layer of the learning block.

In some embodiments, prior to step 1390, the BS 1302 may transmit, to the UE 1301, information indicative of at least one of time resource, frequency resource, or spatial resource for reporting loss of the learning block or loss convergence status of the learning block. Such information may be transmitted to the UE 1301 via RRC signaling, MAC-CE signaling, DCI signaling or event signaling indicating when to report the loss of the learning block or the loss convergence status of the learning block.

By virtue of some aspects of the present disclosure, an AI/ML model may be trained using forward-propagation-only (FO) training methods over air interface in future communications systems, such as 6G wireless network systems.

By virtue of some aspects of the present disclosure, forward-propagation-only (FO) training methods and backpropagation (BP) training methods may be flexibly adapted for training an AI/ML model. In other words, some aspects of the present disclosure may support flexible adaptation of FO and BP training methods.

By virtue of some aspects of the present disclosure, incremental AI/ML model learning may be supported thereby reducing AI/ML model training overhead and/or signaling overhead for transmission of AI/ML model parameters, especially compared to full AI/ML model training (e.g., training whole AI/ML model).

Examples of devices (e.g., ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g., in relation to FIG. 13. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

AI Artificial intelligence
LTE Long Term Evolution
NR New Radio
BP Backward Propagation or Backpropagation
BWP Bandwidth part
BS Base Station
CA Carrier Aggregation
CC Component Carrier
CG Cell Group
CSI Channel state information
CSI-RS Channel state information Reference Signal
DNN Deep neutral network
DC Dual Connectivity
DCI Downlink control information
DL Downlink
DL-SCH Downlink shared channel
EN-DC E-UTRA NR dual connectivity with MCG using E-UTRA and SCG using NR
FL Federated Learning
FO Forward only or Forward-propagation only
gNB Next generation (or 5G) base station
HARQ-ACK Hybrid automatic repeat request acknowledgement
HSIC Hilbert-Schmidt independence criterion
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

1. A method comprising:
receiving training configuration information for a learning block comprising one or more successive layers of an artificial intelligence or machine learning (AI/ML) model, the one or more successive layers of the learning block being a subset of less than all layers of the AI/ML model;
determining the learning block using the training configuration information;
training the AI/ML model or the learning block using the training configuration information; and
transmitting one or more parameters associated with the learning block.

2. The method of claim 1, further comprising:
transmitting information indicating computing capability of a user equipment (UE).

3. The method of claim 1, wherein the training configuration information indicates at least one of:
a first layer of the learning block;
a last layer of the learning block;
an AI/ML model training pattern indicating a plurality of blocks in the AI/ML model and a respective number of iterations for each of the plurality of blocks, the plurality of blocks including the learning block;
information related to one or more preceding layers to the learning block;
a first kernel function for AI/ML model training input data; or
a second kernel function for AI/ML model training output data.

4. The method of claim 3, wherein the one or more preceding layers are frozen, and the learning block of the AI/ML model is trained using a backpropagation algorithm.

5. The method of claim 1, further comprising:
receiving a switching signal to start training the learning block via radio resource control (RRC) signaling, media access control-control element (MAC-CE) signaling, downlink control information (DCI) signaling, or event signaling indicating completion of a preceding learning block training.

6. The method of claim 5, further comprising:
transmitting at least one of an indication for loss of at least one layer of the one or more successive layers of the learning block or an indication for updating the one or more parameters associated with the learning block.

7. The method of claim 5, further comprising:
receiving an instruction for at least one of:
(1) transmitting kernelized AI/ML model training input data and kernelized AI/ML model training output data, or
(2) suspending the training the AI/ML model;
performing the suspending the training the AI/ML model; and
transmitting the kernelized AI/ML model training input data and the kernelized AI/ML model training output data.

8. An apparatus comprising:
at least one processor coupled with a memory storing processor-executable instructions that, when executed, cause the apparatus to perform operations including:
receiving training configuration information for a learning block comprising one or more successive layers of an artificial intelligence or machine learning (AI/ML) model, the one or more successive layers of the learning block are a subset of less than all layers of the AI/ML model;
determining the learning block using the training configuration information;
training the AI/ML model or the learning block using the training configuration information; and
transmitting one or more parameters associated with the learning block.

9. The apparatus of claim 8, the operations further comprising:
transmitting information indicative of computing capability of the apparatus.

10. The apparatus of claim 8, wherein the training configuration information indicates at least one of:
a first layer of the learning block;
a last layer of the learning block;
an AI/ML model training pattern indicating a plurality of blocks in the AI/ML model and a respective number of iterations for each of the plurality of blocks, the plurality of blocks including the learning block;
information related to one or more preceding layers to the learning block;
a first kernel function for AI/ML model training input data; or
a second kernel function for AI/ML model training output data.

11. The apparatus of claim 8, the operations further comprising:
receiving a switching signal to start training the learning block via radio resource control (RRC) signaling, media access control-control element (MAC-CE) signaling, downlink control information (DCI) signaling, or event signaling indicating completion of a preceding learning block training.

12. The apparatus of claim 11, the operations further comprising:
transmitting at least one of an indication for loss of at least one layer of the one or more successive layers of the learning block or an indication for updating the one or more parameters associated with the learning block.

13. The apparatus of claim 11, the operations further comprising:
receiving an instruction for at least one of:
(1) transmitting kernelized AI/ML model training input data and kernelized AI/ML model training output data, or
(2) suspending the training the AI/ML model;
performing the suspending the training the AI/ML model; and
transmitting the kernelized AI/ML model training input data and the kernelized AI/ML model training output data.

14. An apparatus comprising:
at least one processor coupled with a memory storing processor-executable instructions that, when executed, cause the apparatus to perform operations including:
transmitting training configuration information for a learning block comprising one or more successive layers of an artificial intelligence or machine learning (AI/ML) model, the one or more successive layers of the learning block being a subset of less than all layers of the AI/ML model, wherein the training configuration information is to be used for:
(1) determining the learning block, and
(2) training the AI/ML model or the learning block; and
receiving one or more parameters associated with the learning block.

15. The apparatus of claim 14, the operations further comprising:
receiving information indicating computing capability of a user equipment (UE).

16. The apparatus of claim 14, wherein the training configuration information indicates at least one of:
a first layer of the learning block;
a last layer of the learning block;
an AI/ML model training pattern indicating a plurality of blocks in the AI/ML model and a respective number of iterations for each of the plurality of blocks, the plurality of blocks including the learning block;
information related to one or more preceding layers to the learning block;
a first kernel function for AI/ML model training input data; or
a second kernel function for AI/ML model training output data.

17. The apparatus of claim 16, wherein the one or more preceding layers are frozen, and the learning block of the AI/ML model is trained using a backpropagation algorithm.

18. The apparatus of claim 14, the operations further comprising:
transmitting a switching signal to start training the learning block via radio resource control (RRC) signaling, media access control-control element (MAC-CE) signaling, downlink control information (DCI) signaling, or event signaling indicating completion of a preceding learning block training.

19. The apparatus of claim 18, the operations further comprising:
receiving at least one of an indication for loss of at least one layer of the one or more successive layers of the learning block or an indication for updating the one or more parameters associated with the learning block.

20. The apparatus of claim 18, to the operations further comprising:
transmitting an instruction for at least one of:
(1) transmitting kernelized AI/ML model training input data and kernelized AI/ML model training output data, or
(2) suspending the training the AI/ML model; and
receiving the kernelized AI/ML model training input data and the kernelized AI/ML model training output data.
